(19) United States
(12) Patent Application Publication
(10) Pub. No.: US 2022/0097602 A1
(43) Pub. Date: Mar. 31, 2022

(54) VEHICLE LIGHTING DEVICE

(71) Applicant: ICHIA TECHNOLOGIES,INC., Taoyuan City (TW)

(72) Inventors: JEN-CHENG CHEN, Taoyuan City (TW); SHIH-FU YU, Taoyuan City (TW); YAN-HAI ZHANG, Suzhou (CN)

(21) Appl. No.: 17/032,042

(22) Filed: Sep. 25, 2020

(51) Int. Cl. B60Q 3/82; F21V 8/00; B60Q 3/51

(52) U.S. Cl. CPC B60Q 3/82; G02B 6/006; B60Q 3/51; G02B 6/0041; G02B 6/0083

(57) ABSTRACT

A vehicle lighting device is provided. The vehicle lighting device includes a main body and a connecting unit. The main body has an upper film, a lower film, a light guide filler, and at least one lower light-emitting element. The upper film has a setting area and a light-permeable layer at a center of the setting area. A distance spaced apart between an edge of the light-permeable layer and an edge of the setting region is no more than 5 cm. The at least one lower light-emitting element is embedded in the light guide filler arranged between the lower film and the upper film and is located on a part of the setting region defined by orthogonally projecting the lower conductive layer onto the setting region. The connecting unit can electrically connect to a control circuit to control the at least one lower light-emitting element.

### FIELD OF THE DISCLOSURE

The present disclosure relates to a lighting device, and more particularly to a vehicle lighting device.

### BACKGROUND OF THE DISCLOSURE

A conventional vehicle lighting device has a contact plate, an additional circuit board, a plurality of light shielding members, and a plurality of light-emitting elements. The light shielding members arranged between the contact plate and the additional circuit board are spaced apart from each other. The conventional vehicle lighting device has a plurality of light channels that are formed between any two adjacent light shielding members. The light-emitting elements are each disposed on the additional circuit board and located in the light channels. When a finger touches the contact plate, a charge path is established, so that the contact plate generates a charge accumulation. The light-emitting elements are triggered according to an amount of the charge accumulation, and emit light out of the contact plate through the light channels.

However, a predetermined distance must be reserved between the contact plate and the additional circuit board of the conventional vehicle lighting device so as to dispose the light channels, such that the light emitted from the light-emitting elements can be guided out of the contact plate through the light channels. Nevertheless, the aforementioned design of the conventional vehicle lighting device has a thicker overall thickness and heavier weight.

### SUMMARY OF THE DISCLOSURE

In response to the above-referenced technical inadequacies, the present disclosure provides a vehicle lighting device to effectively improve on the issues associated with the conventional vehicle lighting devices.

In one aspect, the present disclosure provides a vehicle lighting device, which includes a main body and a connecting unit. The main body has an upper film, a lower film, a light guide filler, and at least one lower light-emitting element. The upper film has an upper covering portion. The upper covering portion has a setting region and a light-permeable layer that is arranged at a center of the setting region that is capable of being penetrated by a light. An edge of the light-permeable layer is spaced apart from an edge of the setting region by a first distance that is equal to or less than 5 cm. The lower film is spaced apart from the upper film by a second distance and has a lower covering portion. The second distance is greater than any one of a thickness of the lower film and a thickness of the upper film. An area of the lower covering portion is substantially equal to an area of the upper covering portion. The lower covering portion has a lower conductive layer on a side surface thereof facing the upper covering portion. The light guide filler is completely filled in a space between the lower film and the upper film. The at least one lower light-emitting element is embedded in the light guide filler and is located on a part of the setting region defined by orthogonally projecting the lower conductive layer onto the setting region. The at least one lower light-emitting element is electrically connected to the lower conductive layer and is capable of emitting light to the light-permeable layer through the light guide filler. The connecting unit is electrically connected to the main body. The connecting unit is configured to electrically connect to a control circuit that is configured to control the at least one lower light-emitting element.

In another aspect, the present disclosure provides a vehicle lighting device, which includes a main body and a connecting unit. The main body has an upper film, a lower film, a light guide filler, and at least one lower light-emitting element. The upper film has an upper covering portion, and the upper covering portion has an upper conductive layer on a side surface thereof. The upper covering portion has a setting region and a light-permeable layer that is arranged at a center of the setting region that is capable of being penetrated by a light. An edge of the light-permeable layer is spaced apart from an edge of the setting region by a first distance that is equal to or less than 5 cm. The lower film is spaced apart from the upper film by a second distance and has a lower covering portion. The second distance is greater than any one of a thickness of the lower film and a thickness of the upper film. An area of the lower covering portion is substantially equal to an area of the upper covering portion. The light guide filler is completely filled in a space between the lower film and the upper film. The at least one upper light-emitting element is embedded in the light guide filler and is located on a part of the setting region defined by orthogonally projecting the upper conductive layer onto the setting region. The at least one upper light-emitting element is electrically connected to the upper conductive layer and is capable of emitting light to the light-permeable layer through the light guide filler. The connecting unit is electrically connected to the main body. The connecting unit is configured to electrically connect to a control circuit that is configured to control the at least one upper light-emitting element.

Therefore, by virtue of “the at least one lower light-emitting element arranged on the part of the setting region defined by orthogonally projecting the lower conductive layer onto the setting region” or “the upper light-emitting element arranged on the part of the setting region defined by orthogonally projecting the upper conductive layer onto the setting region”, the at least one lower light-emitting element or the at least one upper light-emitting element can directly emit light out of the light-permeable layer through the light guide filler so as to cause the vehicle lighting device of the present disclosure to be lighter and thinner.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a schematic perspective view of a vehicle lighting device disposed and assembled in a vehicle according to a first embodiment of the present disclosure.

FIG. 2 is a schematic perspective view of the vehicle lighting device according to the first embodiment of the present disclosure.

FIG. 3 is another schematic perspective view of the vehicle lighting device according to the first embodiment of the present disclosure.

FIG. 4 is a schematic cross-sectional view taken along line IV-IV of FIG. 2

FIG. 5 is a schematic enlarged view of section V of FIG. 4.

FIG. 6 is a schematic enlarged view of section VI of FIG. 4.

FIG. 7 is a schematic perspective view of a vehicle lighting device according to a second embodiment of the present disclosure.

FIG. 8 is a schematic cross-sectional view taken along line VIII-VIII of FIG. 7.

FIG. 9 is a schematic cross-sectional view of a vehicle lighting device according to a third embodiment of the present disclosure.

FIG. 10 is a schematic cross-sectional view of a vehicle lighting device according to a fourth embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

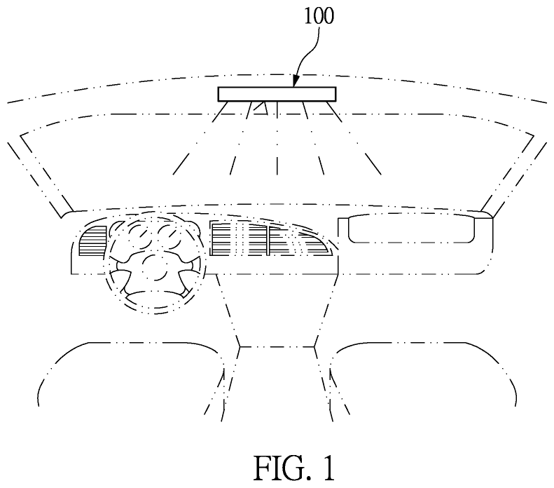

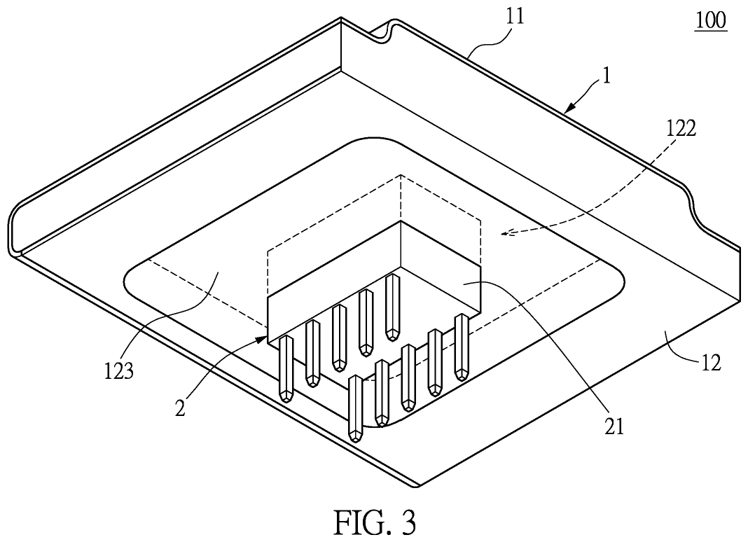

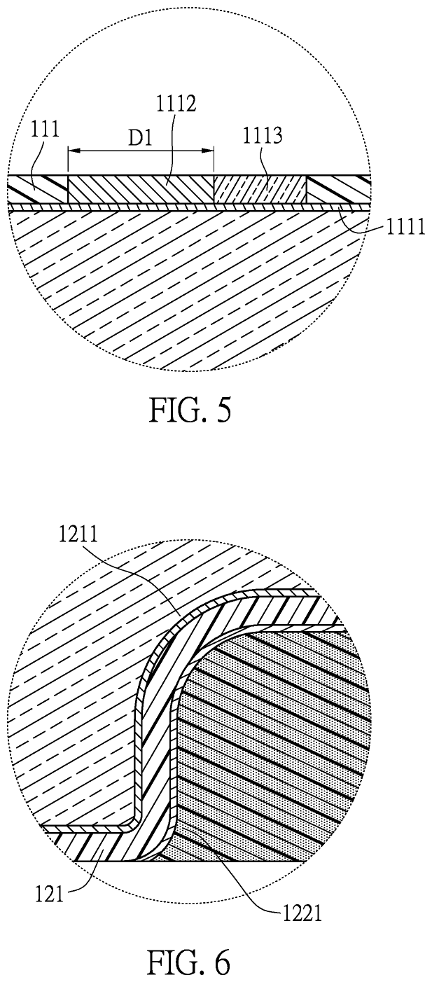

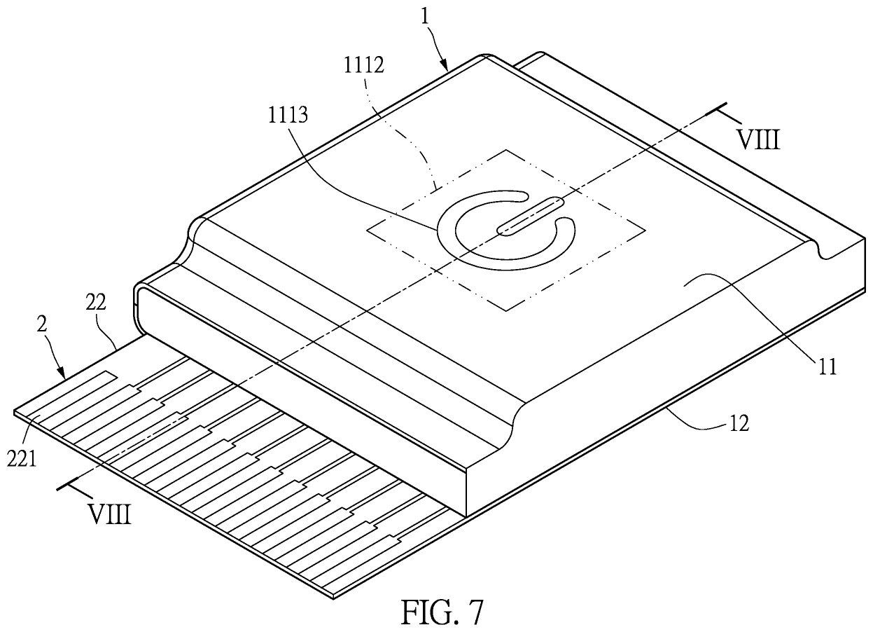

Referring to FIG. 1 to FIG. 6, a first embodiment of the present disclosure provides a vehicle lighting device 100, in particular, a vehicle lighting device 100 that is installed on a vehicle body and operated by touch (as shown in FIG. 1). In other words, any touch device that is not used for lighting purposes is not the vehicle lighting device 100 of the present disclosure (e.g., smartphones or tablet computers).

Referring to FIG. 1 to FIG. 3, the vehicle lighting device 100 includes a main body 1 and a connecting unit 2 that is electrically connected to the main body 1. Specifically, the connecting unit 2 is configured to electrically connect to a control circuit (not shown in the drawings), so that the control circuit can control the vehicle lighting device 100. The following description describes the structure and connection relation of each component of the vehicle lighting device 100.

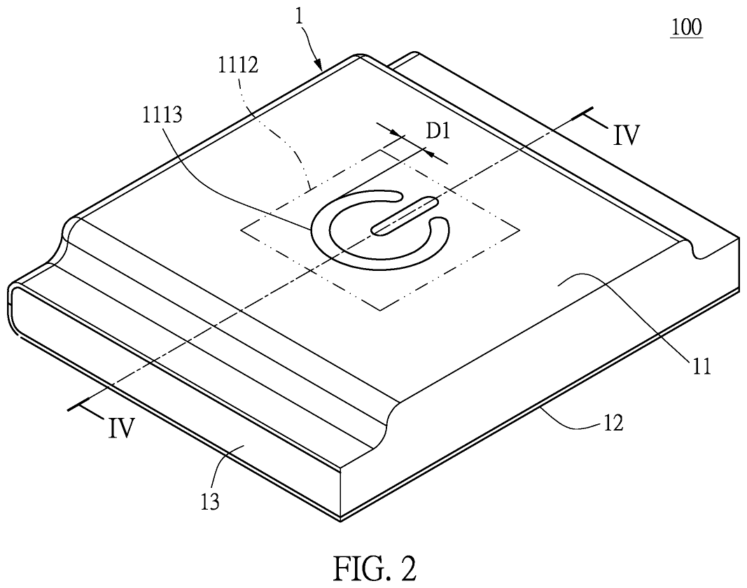

Referring to FIG. 2 to FIG. 4, the main body 1 includes an upper film 11, a lower film 12 spaced apart from the upper film 11, a light guide filler 13 arranged between the upper film 11 and the lower film 12, and at least one lower light-emitting element 14 is disposed in the light guide filler 13.

The upper film 11 has an upper covering portion 111. The upper covering portion 111 has an upper conductive layer 1111 and a setting region 1112. The upper conductive layer 1111 in the present embodiment is located on a side surface of the upper covering portion 111 and has a touch circuit (not shown in the drawings) located in the setting region 1112. The touch circuit is configured to establish a charge path with a charged body (not shown in the drawings), and the charge of the charged body can move into the upper conductive layer 1111 along the charge path.

Specifically, a part of the upper covering portion 111 in the present embodiment is in a shape of a convex structure, and the setting region 1112 is located on the convex structure of the upper covering portion 111. Accordingly, a user can recognize a position of the setting area 1112 by a touch method and feel the touch circuit, but the present disclosure is not limited thereto. For example, the upper covering portion 111 in other embodiments may also be a completely flat structure, and the touch circuit is disposed on the upper covering portion 111.

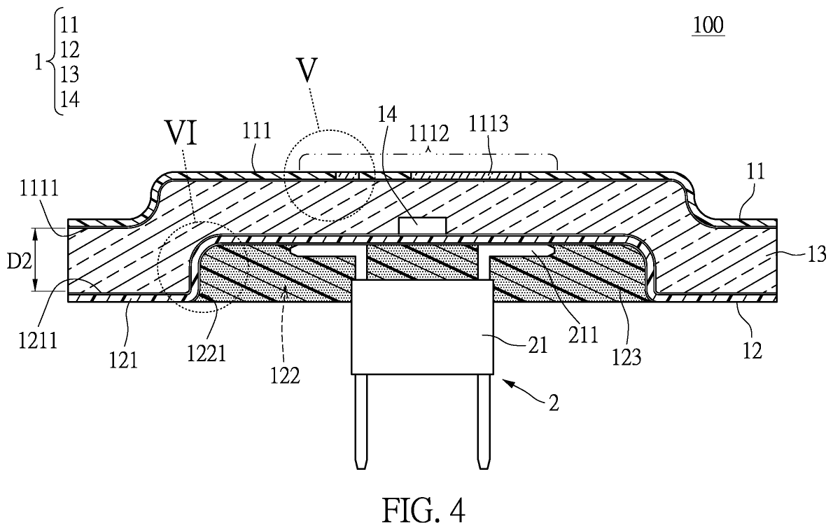

Referring to FIG. 4 to FIG. 6, the upper covering portion 111 has a light-permeable layer 1113 arranged at a center of the setting region 1112 and that is capable of being penetrated by a light. An edge of the light-permeable layer 1113 is spaced apart from an edge of the setting region 1112 by a first distance D1 that is equal to or less than 5 cm. The light-permeable layer 1113 in the present embodiment is a transparent symbol (e.g., a power symbol), but the present embodiment is not limited thereto. For example, the light-permeable layer 1113 may also be a transparent rectangular block for illumination purposes.

The lower film 12 is spaced apart from the upper film 11 by a second distance D2 that is greater than any one of a thickness of the lower film 12 and a thickness of the upper film 11. The second distance D2 is preferably between 0.5 mm and 3.5 mm. The lower film 12 has a lower covering portion 121, and an area of the lower covering portion 121 is substantially equal to an area of the upper covering portion 111. The lower covering portion 121 has a lower conductive layer 1211 facing the upper covering portion 111.

Further, the lower film 12 has a groove 122 away from the upper film 11 and a fixed filler 123 that is filled in the groove 122. An inner side of the groove 122 has a connecting layer 1221 electrically connected to the lower conductive layer 1211.

Specifically, the groove 122 is recessed toward a direction of the upper film 11, and a depth of the groove 122 is equal to or less than 1.5 cm. The connecting layer 1221 is arranged on the inner side of the groove 122. The fixed filler 123 in the present embodiment is a non-conductive material (e.g., a transparent resin or a translucent resin), and the groove 122 is fully filled with the fixed filler 123 by plastic injection molding.

The light guide filler 13 is arranged between the lower film 12 and the upper film 11. Specifically, the light guide filler 13 in the present embodiment is made of a light-transmissive and non-conductive material (e.g., the transparent resin or the translucent resin), and a space between the lower film 12 and the upper film 11 is fully filled with the light guide filler 13 by plastic injection molding. In practical application, the light guide filler 13 and the fixed filler 123 can be made of the same material to facilitate production, but the present embodiment is not limited thereto.

The connecting unit 2 is electrically connected to the main body 1. Specifically, the connecting unit 2 in the present embodiment is a connector 21 (e.g., dual in-line package), and an end of the connector 21 has a pin 211 that is embedded in the fixed filler 123. In other words, a height of the pin 211 is not greater than 1.5 cm, so that the pin 211 can be completely covered by the fixed filler 123, but the present embodiment is not limited thereto. For example, in another embodiment of the present disclosure that is not shown, when the pin 211 is 0.5 cm, the groove 122 may not be fully filled with the fixed filler 123 but can still completely cover and fix the pin 211 in place.

The connector 21 is electrically connected to the connecting layer 1221 through the pin 211. The connector 21 is configured to electrically connect to the control circuit that controls the at least one lower light-emitting element 14.

The at least one lower light-emitting element 14 is embedded in the light guide filler 13 and is located on a part of the setting region 1112 defined by orthogonally projecting the lower conductive layer 1211 onto the setting region 1112. The at least one lower light-emitting element 14 is electrically connected to the lower conductive layer 1211 and is capable of emitting a light to the light-permeable layer 1113 through the light guide filler 13. Specifically, the at least one lower light-emitting element 14 may emit light from its front side or its lateral sides. The light emitted from the at least one lower light-emitting element 14 can be directly emitted to the outside of the light-permeable layer 1113 by the light guide filler 13.

In addition, when the charged body (e.g., a finger) touches a contact circuit on the upper conductive layer 1111, the charged body establishes the electric charge action path and conducts the electric charge to the control circuit through the connector 21. The control circuit can drive the at least one lower light-emitting element 14 according to the amount of the electric charge, so that the light emitted from the at least one lower light-emitting element 14 is emitted to the outside of the light-permeable layer 1113.

### Second Embodiment

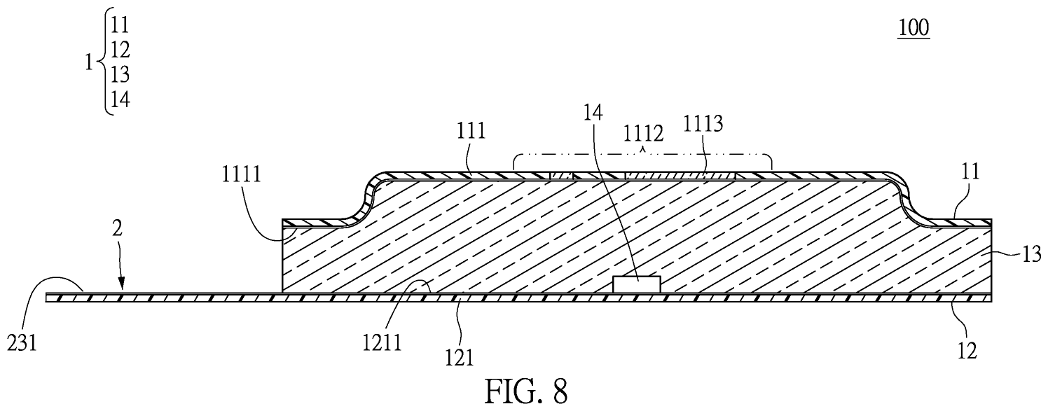

Referring to FIG. 7 and FIG. 8, a second embodiment of the present disclosure provides a vehicle lighting device 100. The present embodiment is similar to the first embodiment, and the similarities between the present embodiment and the first embodiment will not be repeated. The differences between the present embodiment and the first embodiment are:

The connecting unit 2 in the present embodiment includes a lower connecting end 22 integrally connected to the lower covering portion 121, and the lower connecting end 22 has a lower printed circuit layer 221 facing the upper film 11. The lower printed circuit layer 221 is electrically connected to the lower conductive layer 1211, and the lower connecting end 22 is configured to electrically connect to the control circuit. In other words, the lower connecting end 22 will not be blocked by the light guide filler 13, so that the lower printed circuit layer 221 of the lower connecting end 22 can be directly electrically connected to the control circuit.

### Third Embodiment

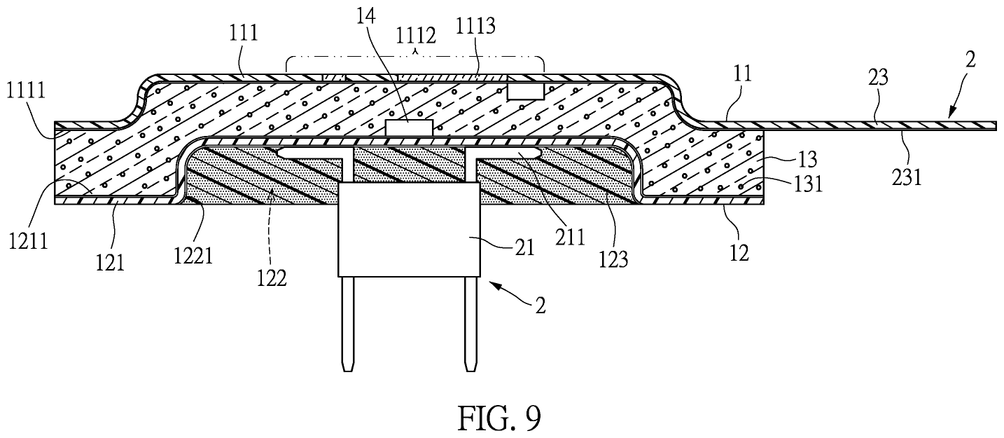

Referring to FIG. 9, a third embodiment of the present disclosure provides a vehicle lighting device 100. The present embodiment is similar to the first embodiment, and the similarities between the present embodiment and the first embodiment will not be repeated herein. The differences between the present embodiment and the first embodiment are as follows.

The vehicle lighting device 100 further includes at least one upper light-emitting element 15 embedded in the light guide filler 13. The at least one upper light-emitting element 15 is located on a part of the setting region 1112 defined by orthogonally projecting on the upper conductive layer 1111, and the at least one upper light-emitting element 15 is electrically connected to the upper conductive layer 1111, and the at least one upper light-emitting element 15 can emit a light to the light-permeable layer 1113 through the light guide filler 13.

Specifically, the at least one upper light-emitting element 15 may emit light from its front side or its lateral sides. The light guide filler 13 further includes a plurality of scattering particles 131 (e.g., light guide powder), and the light emitted from the at least one upper light-emitting element 15 can be emitted to the outside of the light-permeable layer 1113 in a scattering manner through the scattering particles 131.

It should be noted that the light guide filler 13 and the fixed filler 123 in this embodiment are only different from the scattering particles 131 arranged in the light guide filler 13. However, in practical applications, the fixed filler 123 may also be provided with the scattering particles 131, that is, the light guide filler 13 and the fixed filler 123 may have the same composition to facilitate production.

The connecting unit 2 in the present embodiment further includes an upper connecting end 23 integrally connected to the upper covering portion 111, and a side of the upper connecting end 23 facing the lower film 12 has an upper printed circuit layer 231 that is electrically connected to the upper conductive layer 1111. The upper connecting end 23 is configured to electrically connect to the control circuit. That is to say, the upper connecting end 23 will not be blocked by the light guide filler 13, so that the upper printed circuit layer 231 of the upper connecting end 23 can be directly electrically connected to the control circuit. In other words, the connector 21 and the upper connecting end 23 of the connecting unit 2 are electrically connected to the control circuit at the same time, so that the control circuit can simultaneously control the at least one lower light-emitting element 14 and the at least one the upper light-emitting element 15.

### Fourth Embodiment

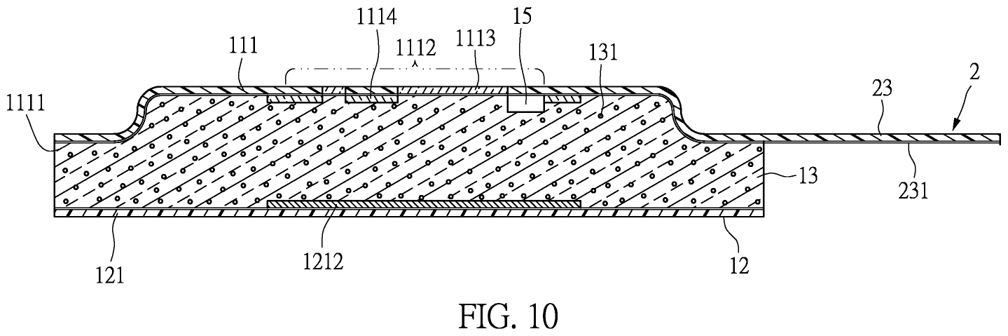

Referring to FIG. 10, a fourth embodiment of the present disclosure provides a vehicle lighting device 100. The present embodiment is similar to the third embodiment, and the similarities between the present embodiment and the third embodiment will not be repeated herein. The differences between the present embodiment and the third embodiments are: the vehicle lighting device 100 does not have the at least one lower light-emitting element 14, and the connecting unit 2 does not have the connector 21.

Specifically, the upper covering portion 111 further has an upper light guide layer 1114 disposed on a surface of the upper covering portion 111 facing the lower covering portion 121. In other words, the upper light guide layer 1114 in the present embodiment is disposed on the surface of the upper covering portion 111. The lower covering portion 121 has a lower light guide layer 1212 that is disposed on a surface of the lower covering portion 121 facing the upper covering portion 111. The upper light guide layer 1114 and the lower light guide layer 1212 can be matched to reflect the light emitted from the at least one upper light-emitting element 15 to the light-transmitting layer 1113. In other words, the light emitted from the at least one upper light-emitting element 15 can be reflected back and forth between the upper light guide layer 1114 and the lower light guide layer 1212, and then finally emitted from the light-permeable layer 1113, but the present embodiment is not limited thereto. For example, in other embodiments of the present disclosure that are not shown, the upper covering portion 111 may not have the upper light guide layer 1114, and the light emitted from the at least one upper light-emitting element 15 is only reflected to the light-transmitting layer 1113 through the lower light guide layer 1212.

In conclusion, by virtue of “the at least one lower light-emitting element 14 arranged on the part of the setting region 1112 defined by orthogonally projecting the lower conductive layer 1211 onto the setting region 1112” or “the upper light-emitting element 15 arranged on the part of the setting region 1112 defined by orthogonally projecting the upper conductive layer 1111 onto the setting region 1112”, the at least one lower light-emitting element 14 or the at least one upper light-emitting element 15 can directly emit light out of the light-permeable layer 1113 through the light guide filler 13 so as to cause the vehicle lighting device 100 of the present disclosure to be lighter and thinner.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A vehicle lighting device, comprising:
a main body including:
an upper film having an upper covering portion, wherein the upper covering portion has a setting region and a light-permeable layer that is arranged at a center of the setting region that is capable of being penetrated by a light, and wherein an edge of the light-permeable layer is spaced apart from an edge of the setting region by a first distance that is equal to or less than 5 cm;
a lower film spaced apart from the upper film by a second distance and having a lower covering portion, wherein the second distance is greater than any one of a thickness of the lower film and a thickness of the upper film, wherein an area of the lower covering portion is substantially equal to an area of the upper covering portion, and wherein the lower covering portion has a lower conductive layer on a side surface thereof facing the upper covering portion;
a light guide filler completely filled in a space between the lower film and the upper film; and
at least one lower light-emitting element embedded in the light guide filler and located on a part of the setting region defined by orthogonally projecting the lower conductive layer onto the setting region, wherein the at least one lower light-emitting element is electrically connected to the lower conductive layer and is capable of emitting light to the light-permeable layer through the light guide filler; and
a connecting unit electrically connected to the main body, wherein the connecting unit is configured to electrically connect to a control circuit that is configured to control the at least one lower light-emitting element.

2. The vehicle lighting device according to claim 1, wherein the lower film has a groove on a side surface thereof away from the upper film and a fixed filler that is completely filled in the groove, and wherein an inner side of the groove has a connecting layer electrically connected to the lower conductive layer, and a depth of the groove is equal to or less than 1.5 cm, wherein the connecting unit includes a connector having a pin that is embedded in the fixed filler, and the pin is electrically connected to the lower conductive layer through the connecting layer, and the connector is configured to electrically connect to the control circuit.

3. The vehicle lighting device according to claim 2, wherein the upper covering portion has an upper conductive layer on a side surface thereof facing the lower film, wherein the connecting unit further includes an upper connecting end integrally connected to the upper covering portion, and a side surface of the upper connecting end facing the lower film has an upper printed circuit layer that is electrically connected to the upper conductive layer, wherein the upper connecting end is configured to electrically connect to the control circuit, and wherein the vehicle lighting device further includes at least one upper light-emitting element embedded in the light guide filler, and the at least one upper light-emitting element is located on a part of the setting region defined by orthogonally projecting the upper conductive layer, and the at least one upper light-emitting element is configured to be controlled by the control circuit so as to emit light to the light-permeable layer through the light guide filler.

4. The vehicle lighting device according to claim 3, wherein the light guide filler has a plurality of scattering particles, and the scattering particles scatter the light emitted from the at least one upper light-emitting element so as to guide the light to enter into the light-permeable layer.

5. The vehicle lighting device according to claim 3, wherein the upper covering portion has an upper light guide layer that is disposed on a surface of the upper covering portion facing the lower covering portion, the lower covering portion having a lower light guide layer that is disposed on a surface of the lower covering portion facing the upper covering portion, and the upper light guide layer and the lower light guide layer are configured to cooperatively reflect the light emitted from the at least one upper light-emitting element to the light-permeable layer.

6. The vehicle lighting device according to claim 1, wherein the connecting unit includes a lower connecting end integrally connected to the lower covering portion, and the lower connecting end has a lower printed circuit layer on a side surface thereof facing the upper film, and wherein the lower printed circuit layer is electrically connected to the lower conductive layer, and the lower connecting end is configured to electrically connect to the control circuit.

7. The vehicle lighting device according to claim 6, wherein the upper covering portion has an upper conductive layer on a side surface thereof facing the lower film, wherein the connecting unit further includes an upper connecting end integrally connected to the upper covering portion, and a side surface of the upper connecting end facing the lower film has an upper printed circuit layer facing the lower film that is electrically connected to the upper conductive layer, wherein the upper connecting end is configured to electrically connect to the control circuit, and wherein the vehicle lighting device further includes at least one upper light-emitting element embedded in the light guide filler, the at least one upper light-emitting element is located on a part of the setting region defined by orthogonally projecting the upper conductive layer, and the at least one upper light-emitting element is configured to be controlled by the control circuit so as to emit light to the light-permeable layer through the light guide filler.

8. The vehicle lighting device according to claim 7, wherein the light guide filler has a plurality of scattering particles, and the scattering particles scatter the light emitted from the at least one upper light-emitting element so as to guide the light to enter into the light-permeable layer.

9. The vehicle lighting device according to claim 7, wherein the upper covering portion has an upper light guide layer that is disposed on a surface of the upper covering portion facing the lower covering portion, the lower covering portion having a lower light guide layer that is disposed on a surface of the lower covering portion facing the upper covering portion, and the upper light guide layer and the lower light guide layer are configured to cooperatively reflect the light emitted from the at least one upper light-emitting element to the light-permeable layer.

10. A vehicle lighting device, comprising:
a main body including:
an upper film having an upper covering portion, and the upper covering portion having an upper conductive layer on a side surface thereof, wherein the upper covering portion has a setting region and a light-permeable layer that is arranged at a center of the setting region that is capable of being penetrated by a light, and wherein an edge of the light-permeable layer is spaced apart from an edge of the setting region by a first distance that is equal to or less than 5 cm;
a lower film spaced apart from the upper film by a second distance and having a lower covering portion, wherein the second distance is greater than any one of a thickness of the lower film and a thickness of the upper film, and wherein an area of the lower covering portion is substantially equal to an area of the upper covering portion;
a light guide filler completely filled in a space between the lower film and the upper film; and
at least one upper light-emitting element embedded in the light guide filler and located on a part of the setting region defined by orthogonally projecting the upper conductive layer onto the setting region, wherein the at least one upper light-emitting element is electrically connected to the upper conductive layer and is capable of emitting light to the light-permeable layer through the light guide filler; and
a connecting unit electrically connected to the main body, wherein the connecting unit is configured to electrically connect to a control circuit that is configured to control the at least one upper light-emitting element.

11. The vehicle lighting device according to claim 10, wherein the light guide filler has a plurality of scattering particles, and the scattering particles scatter the light emitted from the at least one upper light-emitting element so as to guide the light to enter into the light-permeable layer.

12. The vehicle lighting device according to claim 10, wherein the connecting unit is a upper connecting end integrally connected to the upper covering portion, and the upper connecting end has a upper printed circuit layer on a side surface thereof facing the lower film, and wherein the upper printed circuit layer is electrically connected to the upper conductive layer, and the upper connecting end is configured to electrically connect to the control circuit.

13. The vehicle lighting device according to claim 10, wherein the upper covering portion has an upper light guide layer that is disposed on a surface of the upper covering portion facing the lower covering portion, the lower covering portion having a lower light guide layer that is disposed on a surface of the lower covering portion facing the upper covering portion, and the upper light guide layer and the lower light guide layer are configured to cooperatively reflect the light emitted from the at least one upper light-emitting element to the light-permeable layer.
